(19) United States
(12) Patent Application Publication
(10) Pub. No.: US 2022/0108297 A1
(43) Pub. Date: Apr. 7, 2022

(54) SOFTWARE SECURITY SYSTEM AND METHOD FOR PIN ENTRY, STORAGE AND TRANSMISSION TO SOFTWARE-BASED POS (SOFTPOS)

(71) Applicant: KARTEK KART VE BILISIM TEKNOLOJILERI TICARET ANONIM SIRKETI, Istanbul (TR)

(72) Inventors: Ahmet AKGÜN, Istanbul (TR); Hasan YASSIBAS, Istanbul (TR)

(21) Appl. No.: 17/429,685

(22) PCT Filed: Feb. 6, 2020
(86) PCT No.: PCT/TR2020/050080

§ 371 Date: Aug. 10, 2021

(30) Foreign Application Priority Data
Apr. 18, 2019 (TR) 2019/05756

(51) Int. Cl. G06Q 20/32; G06Q 20/40

(52) U.S. Cl. CPC G06Q 20/3227; G06Q 20/4012

(57) ABSTRACT

A secure PIN entry to verify the cardholder in over-limit transactions of mobile devices receiving payment via POS software. The system includes a POS application installed in the mobile device, which allows payment to be received and which is managed by the server application, an L3 business layer that manages the user interface, experience, and workflows of POS application, a POS memory which enables the software operation of security, key creation and cryptographic algorithms for POS application, a POS security layer which ensures that payment is made safely through POS memory, a PIN application that provides the user interface for secure PIN entry and securely forwards PIN entry to the POS application, a PIN memory which enables the software operation of security, key creation and cryptographic algorithms for PIN application, and a PIN security layer that enables secure reception and transmission of the PIN through the PIN memory.

### TECHNICAL FIELD

The invention relates to a system and method that offers a software-based infrastructure, user interface and data flow to secure PIN entry to verify the cardholder for transactions exceeding the limit of the commercial of the shelf mobile devices receiving EMV contactless payments through POS software (softPOS).

### PRIOR ART

Nowadays, the institutions regulating the payment world and the certification authorities receive over-the-limit payments of the commercial of the shelf mobile devices and accordingly PIN entry is not regulated. Several alternatives are being considered for secure PIN entry. The most important of the security elements is that the section that reads the card and the section where the PIN is entered must be separate. In existing POS devices these two sections are in the same box but are separate, they are isolated hardware and certified by certification tests. There are no such separate hardware sections on the commercial of the shelf mobile devices. In existing systems, there is no system or method in which security is provided entirely in software and Whitebox cryptology is used and that offers a hardware-independent solution.

The summary of the application, which has found in the technical survey, with the number 2015/14902 is as follows: “The present invention relates to a security arrangement intended to prevent fraudulent access to a memory module containing sensitive financial data by removing the memory module of a point-of-sale (POS) device. This invention is specifically related to a POS system, which includes a memory module that enables payment processing and is seated inside a chamber portion and electrically connected to an electronic control card via a connector.”

As can be seen, the system is related to the unauthorized access protection system of the POS device memory module and does not mention a configuration that can provide solutions to the above-mentioned disadvantages.

As a result, due to the above-mentioned drawbacks and the inadequacy of the existing solutions, an improvement in the technical field has been required.

### THE PURPOSE OF INVENTION

The invention is intended to provide a structure with different technical features which, unlike the structures used in the present technique, brings a new development to this area.

The primary purpose of the invention is to offer a system and method that offers a software-based infrastructure, user interface and data flow to secure PIN entry to verify the cardholder for transactions exceeding the limit of the commercial of the shelf mobile devices receiving EMV contactless payments through POS software (softPOS).

Another purpose of the invention is to perform software isolation as a solution due to the lack of separate hardware sections on the off the shelf commercial mobile devices.

Another purpose of the invention is to introduce a system and method in which security is provided entirely in software and Whitebox cryptology is used.

Another purpose of the invention is to introduce a system that is designed as two different SDKs, one reading the card and one receiving the PIN, and is completely independent of each other. Thus, the input data that is imported into the mobile device, the keys used for storing and processing them, their encryption, the corresponding application or layers, and the Whitebox layers are separated. The requests and responses to each other will be the interaction of two independent structures in the form of receiving/giving services.

In order to fulfill the above-described purposes, the invention provides a secure PIN entry to verify the cardholder in over-limit transactions of mobile devices receiving payment via POS software, wherein; comprises of
POS application installed in the mobile device, which allows payment to be received and which is managed by the server application,
L3 business layer that manages the user interface, experience, and workflows of POS application,
POS memory, which enables the software operation of security, key creation and cryptographic algorithms for POS application,
POS security layer, which ensures that payment is made safely through POS memory,
PIN application that provides the user interface for secure PIN entry and securely forwards PIN entry to POS application,
PIN memory, which enables the software operation of security, key creation and cryptographic algorithms for PIN application,
PIN security layer that enables secure reception and transmission of the PIN through PIN memory.

The structural and characteristic features and all advantages of the invention outlined in the drawings below and in the detailed description made by referring these figures will be understood clearly, therefore the evaluation should be made by taking these figures and detailed explanation into consideration.

### BRIEF DESCRIPTION OF THE FIGURES

FIG. 1, is the general representation of the system of the invention.

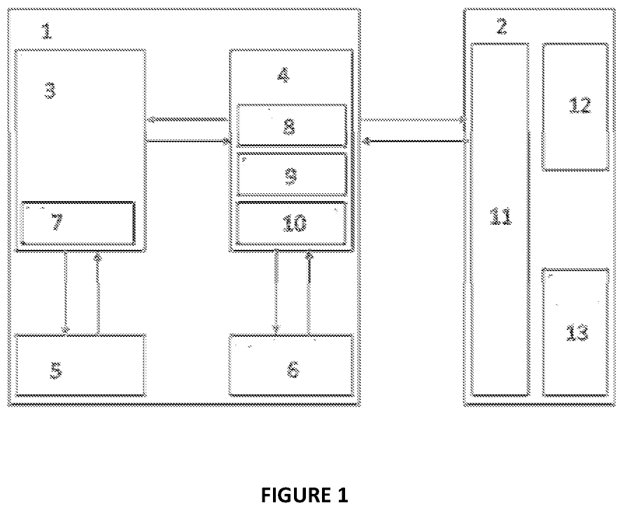

FIG. 2, is the general representation of the method of the invention.

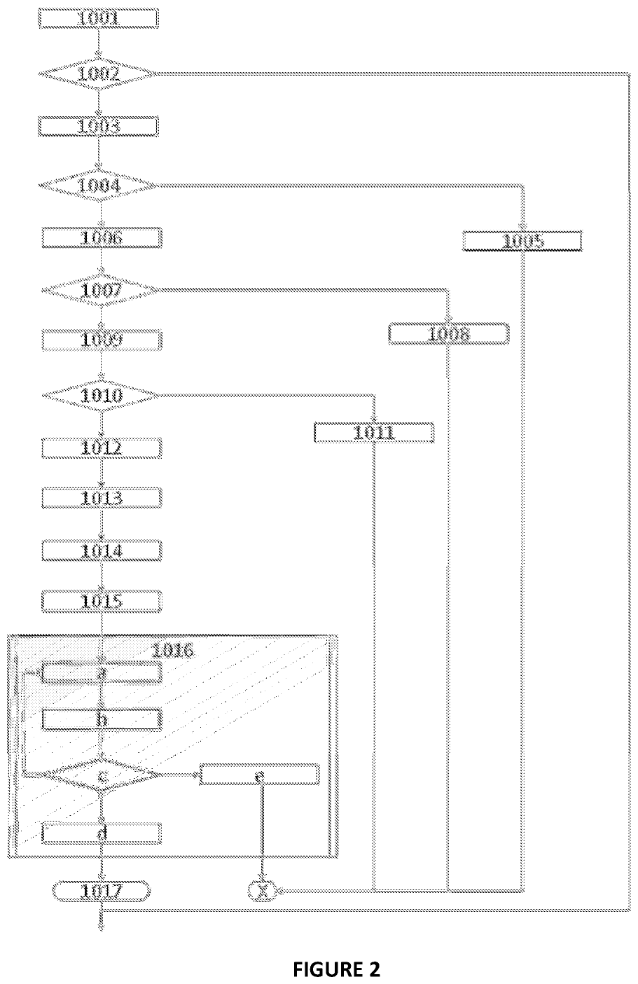

The drawings do not necessarily have to be scaled, and the details that are not necessary to understand the invention may be neglected. Other than that, elements that are substantially identical, or at least have substantially identical functions, are denoted by the same number.

### REFERENCE NUMBERS

1. Mobile Device
2. Server Application
3. PIN application
4. POS application
5. PIN memory (Whitebox)
6. POS memory (Whitebox)
7. PIN security layer
8. L3 Business Layer
9. L2 Kernel
10. POS security layer
11. Communication Layer
12. Control and Approval Application
13. Database Application

### DETAILED DESCRIPTION OF THE INVENTION

In this detailed description, preferred structures of the invention are explained only for a better understanding of the subject matter and without any restrictive effect.

The invention relates to a system and method that offers a software-based infrastructure, user interface and data flow to secure PIN entry to verify the cardholder for transactions exceeding the limit of the commercial of the shelf mobile devices (1) receiving EMV contactless payments through POS software (softPOS).

Mobile devices (1) such as android or mobile phones with a different operating system, or tablets are used in the system of the invention. The mobile device (1) contains the PIN application (3) and the POS application (4). POS application (4) is the application of receiving payment. Contactless payment is made via the NFC antenna by bringing the card closer to the mobile device (1) and payment is made via the POS application (4). The POS application (4) is managed by the server application (2).

L3 Business Layer (8) manages the user interface and experience and workflows of the POS application (4). The L2 kernel (9) is the layer on which the core applications of payment schemes in the POS application operate. POS memory (Whitebox) (6) consists of a library that enables security, key creation, and cryptographic algorithms to work in software for POS application (4). POS security layer (10) is the layer that allows the payment process to be done safely through POS memory (6).

The PIN application (3) provides a user interface for secure PIN entry and securely transmits the PIN entry to the POS application (4). The libraries that enable software operation of the security, key creation, and cryptographic algorithms constitute PIN memory (Whitebox) (5). PIN security layer (7) provides secure reception and transmission of the PIN through PIN memory (5).

The communication layer (11) is the layer that provides secure communication between POS application (4) and server applications (2). Control and approval application (12) is the server application that recognizes mobile device (1) and POS application (4) and performs security checks accordingly. Database application (13) is the standard database application in which the required data is kept.

The process steps realized with the system of the invention are as follows;
Entering payment amount by starting POS application (4) and starting payment flow (1001),
Checking whether the payment amount is above the cardholder verification limit in POS application (4), (1002)
If the payment amount is over the limit, notifying the L3 Business Layer (8) by the L2 kernel (9) where the core applications are running, (1003)
Checking whether the pin application (3) is installed at the L3 Business Layer (8) (1004),
If the PIN application (3) is not installed, displaying an error message to the user and terminating the stream (1005),
Triggering of the PIN application (3) to open if installed (1006),
When opening the PIN application (3), controlling the following items (1007);
   Has the app hash changed?
   Is the device rooted?
   Is debugging performed?
   Is there any overlay attacks?
   Does the application work in the emulator?
   Is there any of the blacklisted apps provided by the server on the device?
   Trying to get a screenshot?
If there is a problem with the controls, the user will be shown the error message and the stream will be terminated (1008).
PIN application (3) to start listening by opening a socket (1009),
POS application (4) tries to connect to opened socket (1010),
If the POS application (4) fails to connect to the said socket, an error or timeout message is displayed and the stream is terminated (1011),
In case the connection is established, sending a special encrypted message over TCP/IP to display the pop-up/pop-up window of the POS application (4), (1012)
   Using an automatically generated AES key to encrypt the said message,
   Encryption of the entire message with the RSA public/Public key in the originally injected Whitebox form by the POS application (4),
The PIN application (3) decodes the received message with the RSA Private key in the originally injected Whitebox form to reach the MEK key in the Whitebox form (1013),
Encryption of the PIN application (3) with the PIN encryption key (PEK) in Whitebox form and in the secure area of memory after filling it with “F” by preparing a PIN sequence in itself according to the PIN format of the payment scheme (1014),
PIN application (3) displays the numeric keypad where the numbers are randomly placed on the screen and wait for the PIN to be entered (1015),
When the user presses a number on the keypad, the PIN application (3) proceeds as follows (1016);
   Random alteration in the places of the numbers (a),
   The PIN sequence is decoded with PEK and the number is placed to the right and then the PIN sequence is erased from memory after being re-encrypted with PEK (b),
   This operation continues until the user presses the Enter button (c),
   PIN application (3) prepares the PIN input message (d);
      If the user presses the “enter” button, the screen result is successful and contains the PIN sequence encrypted with PEK, the entire message is encrypted with the RSA public key in Whitebox form and transmitted to the POS application (4) via TCP/IP socket,
   If the user presses the “Cancel” button, the display will show the result as failure (e),
The POS application (4) decodes the received message with the RSA Private key in the Whitebox form and incorporates the PIN data into the authorization message (1017).

1. A system to provide secure PIN entry to verify the cardholder in over-limit transactions of mobile devices receiving payment via POS software, the system comprising:
a POS application installed in the mobile device, which allows payment to be received and which is managed by a server application;
an L3 business layer that manages a user interface, experience, and workflows of the POS application;
POS memory which enables the software operation of security, key creation and cryptographic algorithms for the POS application;
a POS security layer which ensures that payment is made safely through a POS memory;
a PIN application that provides the user interface for secure PIN entry and securely forwards PIN entry to the POS application;
a PIN memory which enables the software operation of security, key creation and cryptographic algorithms for the PIN application; and
a PIN security layer that enables secure reception and transmission of the PIN through the PIN memory.

2. The system according to claim 1, comprising a L2 kernel in which the core applications of payment schemes in the POS application run.

3. The system according to claim 1, comprising a communication layer, which provides secure communication between the POS application and the server applications.

4. The system according to claim 1, comprising a control and approval application that recognizes the mobile device and the POS application and performs security checks accordingly.

5. The system according to claim 1, comprising a database application in which the required data is kept.

6. A method to provide a secure PIN entry to verify the cardholder in over-limit transactions of mobile devices receiving payment via POS software, the method comprising the steps of:
entering a payment amount by starting the POS application and starting payment flow (1001),
checking whether the payment amount is above a cardholder verification limit in the POS application, (1002)
if the payment amount is over the cardholder verification limit, notifying an L3 Business Layer by a L2 kernel where the core applications are running, (1003)
checking whether a pin application is installed at the L3 Business Layer (1004),
if the PIN application is not installed, displaying an error message to the user and terminating the stream (1005),
triggering of the PIN application to open if installed (1006),
the PIN application to start listening by opening a socket (1009),
the POS application tries to connect to the opened socket (1010),
if the POS application fails to connect to the socket, an error or timeout message is displayed and the stream is terminated (1011),
in case the connection is established, sending a special encrypted message over TCP/IP to display a pop-up window of the POS application, (1012)
using an automatically generated AES key to encrypt the said message,
encryption of the entire message with an RSA Public key in the originally injected Whitebox form by the POS application (4),
the PIN application decodes the received message with the RSA Private key in the originally injected Whitebox form to reach the MEK key in the Whitebox form (1013), encryption of the PIN application with the PIN encryption key (PEK) in Whitebox form and in the secure area of memory after filling it with “F” by preparing a PIN sequence in itself according to the PIN format of the payment scheme (1014),
PIN application displays the numeric keypad where the numbers are randomly placed on the screen and wait for the PIN to be entered (1015),
when the user presses a number on the keypad, the PIN application proceeds as follows (1016);
random alteration in the places of the numbers,
the PIN sequence is decoded with PEK and the number is placed to the right and then the PIN sequence is erased from memory after being re-encrypted with PEK,
This operation continues until the user presses the Enter button,
PIN application (3) prepares the PIN input message;
If the user presses the “enter” button, the screen result is successful and contains the PIN sequence encrypted with PEK, the entire message is encrypted with the RSA public key in Whitebox form and transmitted to the POS application via (4) TCP/IP socket,
if the user presses the “Cancel” button, the display will show the result as a failure,
the POS application decodes the received message with the RSA Private key in the Whitebox form and incorporates the PIN data into the authorization message (1017).

7. The method according to claim 6, characterized by comprising the step of checking of the following items when opening the PIN application; (1007) whether the app Hash has changed,
whether the device is being rooted or not,
whether debugging is performed or not,
whether there is an overlay attack,
whether the application runs in the emulator,
whether there are any apps on the server-issued blacklist on the device,
whether tried to take a screenshot or not.

8. The method according to claim 6, comprising the step of: if there is a drawback in the controls, the user will be shown the error message and flow is terminated (1008).

9. The method according to claim 7, comprising the step of: if there is a drawback in the controls, the user will be shown the error message and flow is terminated (1008).
